(19) United States
(12) Patent Application Publication
(10) Pub. No.: US 2003/0031285 A1
(43) Pub. Date: Feb. 13, 2003

(54) Cryogenic layer of fusion fuel, fuel core and method for fuel core producing

(76) Inventors: Igor Evgenievich Osipov, Balashikha (RU); Tatyana Petrovna Timasheva, Moscow (RU); Lev Sergeevich Yaguzhinsky, Moscow (RU); Elena Rostislavovna Koresheva, Moscow (RU); Oleg Nikolaevich Krokhin, Moscow (RU)

Correspondence Address: LADAS & PARRY, 26 WEST 61ST STREET, NEW YORK, NY, 10023, US

(21) Appl. No.: 10/207,733

(22) Filed: Jul. 29, 2002

(30) Foreign Application Priority Data
Aug. 2, 2001 (RU) 2001121680

(51) Int. Cl. G21J 1/00

(52) U.S. Cl. 376/152

(57) ABSTRACT

The invention belongs to the field of the inertial confinement fusion (ICF), and more specifically it relates to the fuel, in particular to the target with condensed layers of the fuel and the method of its production. The invention enables formation of a transparent cryogenic layer from hydrogen isotopes, which retains its transparency when warmed up from 5K to 16-20K. To produce the above cryogenic layer inside micro spheres a method has been developed of rapid quenching of finely dispersed liquid state in the presence of the doping elements.

The invention belongs to the field of the inertial confinement fusion (ICF), and more specifically it relates to the fuel, in particular to the target with condensed layers of the fuel and the method of its production. The invention enables formation of a transparent cryogenic layer from hydrogen isotopes, which retains its transparency when warmed up from 5K to 16-20K. To produce the above cryogenic layer inside micro spheres a method has been developed of rapid quenching of finely dispersed liquid state in the presence of the doping elements.

### FIELD OF THE INVENTION

The invention belongs to the field of the inertial confinement fusion (ICF), and more specifically it relates to the target, in particular to the cryogenic target with condensed layers of the fuel and the method of its production.

### BACKGROUND OF THE INVENTION

The problem of the utilizing of the thermonuclear fusion reaction for practical purposes has been among the urgent problems for a long time. The research in the field of the controlled thermonuclear fusion has been actively conducted in a number of developed countries.

One of the most advanced trends in the field of controlled thermonuclear fusion is the thermonuclear fusion under micro explosion conditions or the inertial confinement fusion (ICF). Lasers, relativistic electronic beams, beams of light and heavy ions as well as X-ray irradiation induced by the lasers themselves are used in this case to initiate a thermonuclear reaction by the use of the energy sources (drivers).

In ICF retention time of hot plasma is short. In this case to create thermonuclear initiation conditions it is necessary to reach material compression to the density of about 10²⁴-10²⁶ cm⁻³, which is 2-3 times higher than the density of solid state of a substance. Thus, the main task of implementing thermonuclear fusion with inertial limitation is the achievement of the super high compressions.

The research of ICF under micro explosion conditions started to move forward in 1962 after the announcement of N. G. Basov and O. N. Krokhin on laser usability for heating up material to fusion temperatures. It has been proven at present that the maximum compression and heating of material is achievable at symmetrical laser irradiation of a spherical target containing deuterium-tritium mixture (DT-fuel). To optimize operation of such a system it is necessary to find and implement such a target design, which can produce high gain yield of energy. The main part of any target design shall be a spherically symmetrical core representing a shell (or a number of shells adjoining to each other), whose inner wall contains fuel uniformly condensed in the form of uniform liquid or solid layer. The target with such a cryogenic core is called cryogenic target or cryotarget.

As regards this particular invention, only the inner shell is under review, whereas all the rest refers to the outside part of the target design.

Target parameters and in particular the fuel core shall meet strict requirements resultant from theoretical calculations to the degree of sphericity, homogeneity, thickness uniformity of the constituent layers, absence of local non-uniformities on the free surface of condensed fuel. One of the important tasks in production and use of the fuel core is the generation of a cryogenic layer meeting theoretical requirements as well as finding a solution to the problem of the cryotarget delivery into the optical focus of a fusion chamber without sufficient destruction of the fuel layer parameters; the target delivery method having no influence on the process of driver interaction with the matter.

In 1974-1977, in the USA (KMS-Fusion, Ltd.) and in the USSR (Lebedev Physical Institute, or LPI) the experiments have been conducted aimed at freezing of the hydrogen isotopes on the inner surface of the micro spheres from glass and polystyrene. Those experiments demonstrated all the complexity of the production and of the long storage of a uniform solid cryolayer.

In 1978-1979 in Los Alamos and in Livermore Laboratories in the USA there was found a method to produce a transparent layer from normal deuterium at 5 K and at 10 K.

The experiments aimed at the double-beam compression of simple glass cryotargets with liquid DT-layer conducted in 1979-1981 at KMS-Fusion confirmed that already at relatively low laser energies and high thickness uniformity of DT-layer compression degree and yield of fusion neurons get higher as compared to the alternatives with a gas-filled target [1].

In connection with the above developments in 1981-1984 patents 4 154 868, 4 258 075, 4 292 340 and 4 464 413 were issued in the USA relating to the methods and devices for cryotarget production. Inventor's certificate of the USSR #1017099 was issued to V. M. Izgorodin covering the method of production of a cryotarget for inertial confinement fusion.

However, the above references of prior art contain no data on the systematic research of the processes taking place under various environments inside cryogenic targets and, in particular, inside cryogenic fuel core,. Time and temperature dependences of the cryolayer smoothness parameters were studied only qualitatively. The cryolayer formation methods (i.e. the layering methods) did not guarantee retention of the cryolayer parameters in the process of its storing and delivery into the laser focus.

According to [2] the fuel layer shall have the temperatures of about 18.5 K (D2—fuel) or about 19.5 K (DT-fuel) at the point of irradiation of the cryogenic laser target, i.e. close to the melting temperature (Tₘₑₗₜ) of these materials (Tₘₑₗₜ=18.7 K for D2; Tₘₑₗₜ=19.7 K for DT-mixture). The most important parameter of the target quality under these conditions is the smoothness of the fuel layer, i.e. permissible local non-uniformities on the free surface shouldn't be over 0.5-1 μm.

In the equilibrium solid state hydrogen isotopes represent molecular crystals, whereas the samples of solid hydrogens have a specific coarse-grain or a textured structure [3-5]. Such a structure is observed at freezing of the fuel inside the laser targets at the cooling rates of the order of 10 K/sec or less (these modes were realized in the above patents) [6, 7]. Disturbances at the free surface of these layers are very much in excess of the permissible quality criterion.

One of the approaches to the improvement of the quality of crystalline layer is the smoothening of its free surface with the help of some heat source (infra red redistribution, Plasma-heating, beta-layering, etc.) [8-10]. The termination of the external action in this case results in the surface returning to the initial disturbed state and such return is the quicker; the closer is the target temperature to the layer melting temperature. This property of the crystalline layer prejudices the possibility of the ready-made cryogenic target delivery into the fusion burn area without quality deterioration.

Another approach to this problem is the formation of a cryolayer in the form of a metastable amorphous (liquid-like) film, wherein the typical structure non-uniformity is below 30 A [11, 12]. This type of fuel layer features rather smooth surface or at any rate it can be effectively smoothened. The conditions of forming similar metastable states of cryogenic layer at cooling rates higher than 1000 K/sec were described for the first time in paper [13]. However, these and more recent research [14-16] demonstrated that the produced amorphous layer of hydrogen isotope exists stably only in the temperature range below certain threshold Ta, namely (8-11.6) K for D2 and (5-7,7) K for H2. When warmed up above Ta the layer irreversibly passes into equilibrium crystalline form featuring high degree of inhomogineity and rough free surface. This means that by the moment of the laser target irradiation, when the fuel layer is close to the melting temperature, its structure and consequently the surface will be irreversibly “spoilt”.

Thus, despite substantial progress in the field of cryogenic target creation, up to now there is an insistent need for the development of a cryotarget characterized by stable, transparent, smooth, solid cryogenic layer of hydrogen inside a micro sphere.

### BRIEF DESCRIPTION OF THE DRAWINGS

The invention is explained by the drawings wherein

FIG. 1 is a schematic diagram of the layering module and where the numerals stand for: 1—cryostat; 2—container with a batch gas-filled micro spheres; 3—collector; 4—shuttle; 5—layering channel; 6—diagnostics chamber; 7—temperature sensor mounted in the wall of the test chamber; 8—micro sphere.

FIG. 2 is an image of melting of equimolar mixture H2/D2. (c) A polystyrene micro sphere 950 μm in diameter and a cryolayer about 30 μm thick. (a) the initial melting temperature is 16.3K; (b) the stage of crystal melting at 16.6K; (c) final melting temperature is 16.8K

FIG. 3 is an image showing the result of the 3-rd warm-up: appearance of crystalline forms in the transparent layer and their melting: a—transparent layer; b—generation of the mixed condition: transparent+crystalline; c-d-e—process of crystalline melting.

FIG. 4 is a diagram of the cryolayer evolution at cyclic heat treatment:

Rarefaction of 3 mTorr inside diagnostics chamber. 1-st cycle—micro sphere was warmed up from 5 K to 20 K and again cooled to 5 K, and the layer remained transparent in between. In cycles 2-5 there was generation of the mixed condition and evolution of the crystalline melting temperature.

There is gas (helium) at 15 Torr in the chamber. In cycles 6-8 crystalline layer gets molten at 14-14.1 K.

FIG. 5 illustrates the process of dropwise condensation of H₂ and generation of a layer inside a glass micro sphere of 500 μm diameter: micro sphere starting temperature being 40 K, chamber wall temperature −5 K, micro sphere cooling rate −250 K/min, residual gas pressure in the chamber −3 mTorr, micro sphere filling pressure −220 atm (at 300 K).

### SUMMARY OF THE INVENTION

This invention gives a solution to the most of the above-mentioned problems, namely this invention provides a cryogenic target for ICF different from the available in the prior art by its qualitative characteristics, namely it possesses enhanced stability of the cryogenic layer compared to the known targets, it retains transparency and smoothness of the cryogenic layer for longer periods of time and at higher temperatures as compared to the known prototypes.

### The Terms used in the Description of the Invention have the Meaning as Stated in this Chapter, Unless Specified Otherwise in each Particular Case

Fuel core—hollow spherical shell with minimum diameter of 500 μm, fabricated from the material effectively compressing the fuel, e.g., from such, as polystyrene, glass, beryllium, or beryllium deuteride whereas the inner surface of the shell features cryogenic layer from solid fuel such as D2 or DT. The above fuel core is the target or a part of the target design for inertial confinement fusion.

D2—deuterium, DT—deuterium-tritium mixture.

Solid cryogenic layer (or cryolayer)—a layer of fuel cooled down below the melting temperature, which features a thickness uniformity and a smooth free surface at the temperature close to fuel melting.

Stable target—a target with an initially produced cryolayer non-crystallizable in the temperature range under review and even at the melting temperature for the period of one hour and longer.

Transparent target—a target with a cryolayer, wherein no boundaries of micro crystallites are observed due to their insignificance or absence.

Micro sphere—a hollow spherical shell.

Doping elements—elements slowing down the growth of crystal grains, in particular HD, DT, CO, CO₂, NH₃, CH₄ and the like.

Smooth cryogenic layer—a layer, the free surface of which does not contain any local non-uniformities in excess of 0.5 μm.

Cryogenic layer, stable throughout the entire range of the solid phase existence—initially produced layer, non-crystallizable in the temperature range under review and even at the melting temperature.

Quenching—here it means dropwise condensation by means of rapid cooling of the fuel with the doping elements inside the shell and rapid cooling of the fuel drops on non-isothermal deeply cooled shell surface to produce a layer with higher density of defects and to reduce growth rate of the crystal grains. More specifically the quenching in this case means freezing of the fuel on the inner surface of the shell with the rate in excess of 200 K/min. The quenching takes place under substantially non-equilibrium conditions.

One of the aspects of this invention is the provision of the fuel core with transparent cryogenic layer from hydrogen isotopes or their mixture retaining its transparency when warmed up from 5 K to 16-20 K. This aspect is based on the formation of the cryogenic layer in the presence of minor doping elements slowing down crystal grain growth.

Another aspect of the invention is the provision of the fuel core with the cryogenic layer resistant to temperature variations throughout the entire range of existence of the solid phase of this fuel. This aspect is also based on production of the cryogenic layer with minor doping elements slowing down crystal grain growth.

An additional aspect of this invention is the cryogenic layer of the fuel core comprising the hydrogen isotopes or their mixture and the minor doping elements slowing down crystal grain growth.

Another additional aspect of the invention is the development of the method of production of the fuel core with transparent smooth cryogenic layer resistant to temperature variations throughout the entire range of existence of the solid phase. This aspect, in its turn, is based on the production principles of glass materials and/or fine alloys (solid solutions) with minor doping elements slowing down crystal grain growth [17].

According to the invention the fuel core represents a micro sphere, the inner surface of which features a cryogenic layer also containing doping elements, the above layer being stably transparent and smooth throughout the entire range of existence of its solid phase.

In the preferred embodiment of the invention the outside layer of the fuel core micro sphere is made from the material effectively compressing fuel, e.g., such as polystyrene, glass, beryllium or beryllium deuteride.

In another preferred embodiment of the invention the fuel core has the diameter of 500 μm minimum.

In another preferred embodiment the fuel core has the cryogenic layer of fusion fuel, which is made of hydrogen isotopes, e.g., such as D2 or DT.

In the particularly preferred embodiment of the invention the fuel core has the cryogenic layer of fusion fuel, which is minimum 10 μm thick.

In another particularly preferred embodiment of the invention the fuel core has the cryogenic layer of fuel, which contains alloying elements slowing down crystal grain growth, e.g., such as HD, DT, CO, CO₂, NH₃, CH₄ and the like; such elements constituting 3% maximum of the total mass of the cryogenic layer.

In the most preferred embodiment of the invention the fuel core has the cryogenic layer of fuel, which retains its transparency and smoothness over a period of one hour and longer in the temperature range from 5K to the melting temperature of this fuel.

In another preferred embodiment of the invention the fuel core has the extent of roughness of the free surface of the cryogenic layer being 0.5 μm maximum.

A method of producing the fuel core is another object of the invention and it includes the following stages: a) dispersion of the liquid phase of fusion fuel and b) quenching on the micro sphere cooled wall in the presence of doping elements.

In the preferred embodiment of this aspect of the invention dispersion is achieved through dropwise condensation of the fusion fuel vapor inside the micro sphere volume in the presence of doping elements.

In another preferred embodiment of the invention quenching is achieved though settling of the liquid fuel micro drops containing doping elements onto the micro sphere surface cooled below the fuel melting temperature.

In the next preferred embodiment of the method by way of the doping elements use is made of HD, DT, CO, CO₂, NH₃, CH₄ and the like constituting 3% maximum of the total mass of the cryogenic layer.

In one more embodiment of the invention the method ensures production of the fuel core featuring a cryogenic layer of fusion fuel also containing doping elements, the above layer being stably transparent and smooth throughout the entire range of existence of its solid phase.

In the next embodiment of the method the outside layer of the micro sphere is made from the material effectively compressing the fuel, e.g., such as polystyrene, glass, beryllium or beryllium deuteride.

In the additional embodiment the method ensures production of a fuel core with the diameter of 500 μm minimum.

In another embodiment of the method according to the invention the cryogenic layer of the fuel core is made from hydrogen isotopes, e.g., such as D2 or DT.

It is preferable that the cryogenic layer of the fuel core produced by the method proposed shall be minimum 10 μm thick.

The method according to the invention enables to produce cryogenic layer of the fuel core, which contains doping elements slowing down crystal grain growth, e.g., such as HD, DT, CO, CO₂, NH₃, CH₄ and the like; such elements constituting 3% maximum of the total mass of the cryogenic layer.

The above method makes it possible to produce cryogenic layer of the fuel core, which retains its transparency and smoothness over a period of one hour and longer in the temperature range from 5K to melting temperature.

It is particularly preferable for the extent of roughness of the free surface of the cryogenic layer of the fusion core produced by the method to be 0.5 μm maximum.

Another aspect of the invention is the cryogenic layer of the fuel core, which is stably transparent and smooth throughout the entire range of existence of its solid phase.

### DETAILED DESCRIPTION OF THE INVENTION

Outline of the method of solid cryolayer formation inside a micro sphere.

(Fuel core production)

Fuel core is a hollow spherical shell having a condensed fuel layer on its inner surface. The physical layout of the fuel core preparation includes the procedures of micro spheres manufacture and their filling with the fuel gas as it was described in [18,19].

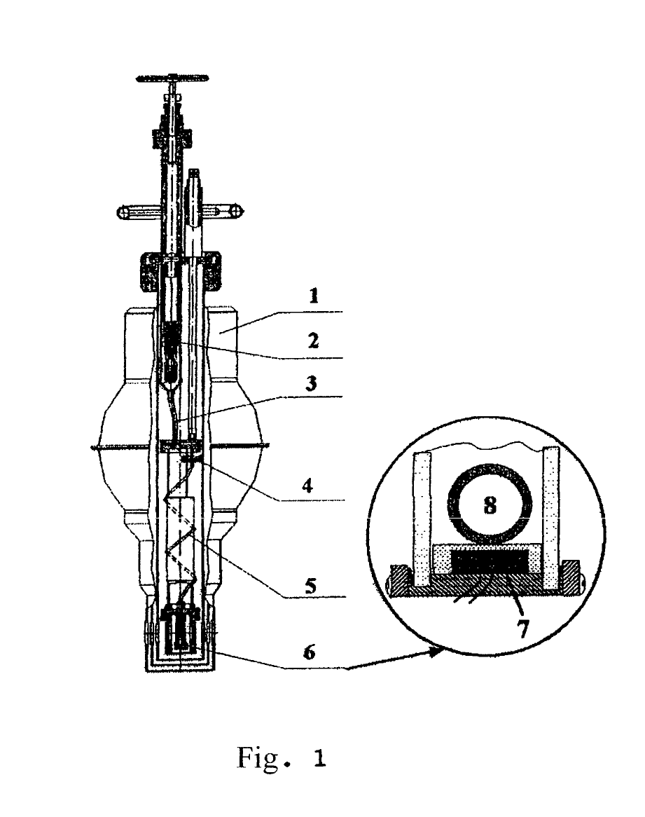

The fuel core has been formed using the special layering module which diagram is shown in FIG. 1. The principle of the module operation and main performance data were given earlier in [20,21]

The cylindrical container (2) with microshells filled with the gas under investigation is placed into the layering module at 300 K.

The layering module was designed as an inset into a commercial helium KG-14 cryostat (1). After the layering module is placed into the cryostat, it is cooled using the liquid helium. If it is necessary, the container is then cooled down to 40 K. Then the micro spheres are replaced into the collector (3). A special shuttle (4) injects a micro sphere from the collector into the layering channel (5) that is a cupper tube of 3 mm in diameter and 1.5 m full length coiled up a vertical metal cylinder as it is shown in FIG. 1. The channel wall is cooled by liquid helium vapor from outside. The micro sphere cools during its collision with the cold wall of the layering channel and the gas inside the micro sphere freezes out on its inner surface. At the channel outlet, the micro sphere is injected into the diagnostic optical chamber (6). At that moment the chamber wall temperature is 4.2-5 K. The time duration of micro sphere residence inside the layering channel is in the range of 4-12 sec.

The cryostat construction allowed to control the temperature of the wall of the diagnostic chamber in the range of 4.2-40 K. The measurement of the wall temperature was made using a diminutive case less semiconductor resistance sensor (7). The sensor size of (˜0.5 mm³) is comparable to the size of a micro sphere. The accuracy of temperature measurements was of ±0.05 K (at 4.2-20 K) and ±0.1K (at 20-40 K).

The layering module construction allows to control a residual gas pressure inside the layering channel in the range of 10⁻⁶-to-600 Torr.

The study of cryolayer evolution at reheating (or cooling) has been performed using an optical diagnostic system including long-focused microscope made on the basis of the industrial microscope IMCL 100×50, personnel computer Pentium-1000 with SCSI-II controller, and MATRIX-430k/12 TV system (production of DeltaTekh, Ltd.). In the process of the experiments the video recording of cryoiayer evolution has been made with the time resolution of 0.04 sec.

The MATRIX system includes a CCD-camera (number of pixels is 752×752, pixel size is 8.6×8.3 μm) and a signal processor. The distinctive feature of the system is saving and then processing the image obtained as a result of the difference of the background picture and the registered signal. This makes it possible to avoid the influence of constant instrumental errors and to perform a preliminary statistical processing of a signal. As a result, a high spatial resolution of cryolayer quality characterization is achieved which is of about 2.5 μm for visual light.

About 100 micro sphers have been studied which were made from glass and polystyrene (0.4-1 mm in diameter) and filled with mixtures of hydrogen isotopes of different composition up to 40-220 atm. Thickness of the cryolayer inside the micro spheres was in the range of 2-to-30 μm at 5 K.

### Determination of the Systematic Error of Cryolayer Temperature Measuring

The correlation between the temperature sensors readings and the real cryogenic layer temperature has been studied in a set of experiments. A schematic of the temperature sensor (7) disposition relative to the micro sphere (8) is shown in FIG. 1.

The experiments have been carried out for solid layers made from H2, D2 and the H2/D2 equimolar mixture. The cryolayer has been formed inside the micro spheres made from polystyrene and from glass.

In the experiments with the H2/D2 equimolar mixture the measurements of the initial and the final melting temperatures of the solid solution have been made. The temperature was measured with the accuracy of ±0.05K.

Under the conditions when the residual gas pressure inside the diagnostic chamber did not exceed 1 mTorr, the heat exchange was mainly defined by the heat conduction through the contact area between the micro sphere and the chamber wall. The micro sphere was heated up with the rate of about 1 K/min. The time delay between the micro sphere temperature and the chamber wall temperature inside the domain of their contact was less then 0.2 s (experimental data), which was measured with the accuracy of 0.04 s.

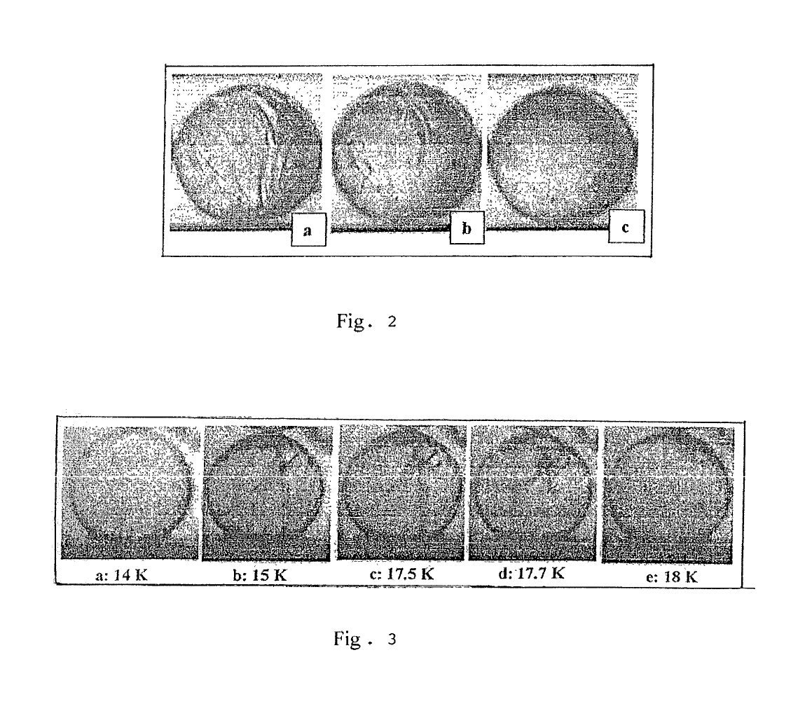

The temperature sensor reading of the initial melting temperature of the cryogenic layer under investigation was 16.3±0.1K. The melting process was finished at 16.8±0.1K (FIG. 2).

According to the diagram of H₂/D₂ solid-solution state [22-24], the initial and the final melting temperatures for the equimolar mixture are 15.79 K and 16.37±0.05 K, respectively.

So, the temperature sensor reading deviation from the real cryogenic layer temperature did not exceed 0.6 K (micro sphere with the cryolayer is inside the vacuum chamber at 1 mTorr environmental pressure, heat input goes only through the contact spot).

Another run of the experiments has been carried out with the cryolayers from 100%H2 and 100%D2. In these experiments the pressure of heat-exchanged helium in the diagnostic chamber was equal to 15 Torr (heat input onto the micro sphere goes both through the contact area and the surrounding gas). The layer melting had happened at 13.9±0.1 K (H2-layer) and at 18.7±0.1 K (D2-layer) that are close to the tabulated triple points of these substances [5].

Thus the accuracy of the temperature sensor readings with respect to the real cryogenic layer temperature was found to be equal to ±0.6 K at the pressure of gaseous helium in the chamber equal to 1 mTorr, and equal to ±0.1 K at the pressure of gaseous helium in the chamber equal to 15 Torr. The results obtained for glass and polystyrene microshells had coincided.

### Formation of Solid Transparent Cryogenic Layer from H₂ with Small HD Doping

A number of the experiments were carried out with the cryogenic layers of H₂/HD mixture where the HD concentration was less than 1%. The glass micro spheres filled with the gas mixture up to 40-200 atm at 300 K have been studied. Diagnostic of the mixture composition was done with a M13305 mass-spectrometer (˜0.005% over a threshold sensitivity) [25]. The study has been done in two stages, namely:

1. Formation of the initial cryolayer inside the micro sphere under its rapid cooling from 40K to 5K;

2. The study of the evolution of the obtained cryolayer under its heating treatment.

At the first stage, the solid cryogenic layer formation in a micro sphere had happened during its movement inside the layering channel. According to our estimations, the micro sphere was cooled inside the channel with the rate of about 200 K/min or more. In this case the solid transparent cryolayer was formed from the H2/HD mixture, which stably kept its transparency under heating up to 16-20 K. The initial proportion of ortho- and para-hydrogen in the mixture does not influence the results.

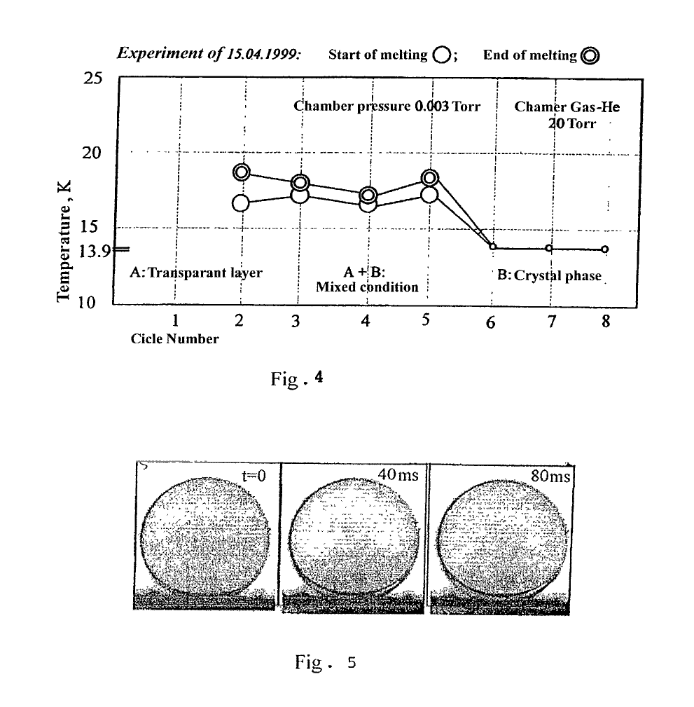

The layer transparency resistance to cycling heating treatment has been investigated. Usually, the layer is reheated from 5 K up to 16-20 K and then cooled down again to 5 K with an average rate of 1 K/min. The layer kept its transparency during 1-2 heating-cooling cycles. Next heating-cooling cycles cause a transition state formation, when separate crystals appear in the transparent substance. The initial melting temperature of the crystals varies within the range of (15.8-20.4)+0.6 K and the melting process takes place within the range of 0.5-2 degree. Experimental results obtained are shown in FIG. 3, FIG. 4 and in Table 1.

TABLE 1*
Experiment of 29.04.2000: Cryogenic layer stability
under heating treatment.

| | Diagnostic | | | | |
|---|---|---|---|---|---|
| | chamber | | | Crystallite | Crystallite |
| | pressure, | | Transparent | formation | melting |
| N | Torr | n | cryolayer stability | T, K | range, K |
| 1 | 0.001 | 3 | First and second reheating | 5.7 | 19-20.4 |
| | | | up to 20 K - the layer is | | |
| | | | transparent | | |
| 2 | 0.001 | 3 | First and second reheating | 10 | 23.7-25.7 |
| | | | up to 20 K - the layer is | | |
| | | | transparent | | |
| 3 | 0.003 | 2 | First reheating up to 20 K - | 8.4 | 17.5-18 |
| | | | the layer is transparent | | |
| 4 | 0.003 | 4 | 1-3 reheating up to 20 K - | 8.2 | 16.7-17.7 |
| | | | the layer is transparent | | |
| 5 | 0.01 | 1 | Firing for 22 min (5 K). | 5 | 15.8-17.1 |
| | | | Crystallite appears in the | | |
| | | | transparent layer | | |
| 6 | 10 | 1 | Full layer crystallization | 5 | 14-14.1 |
| | | | after cham-ber filling with | | |
| | | | 15 Torr gas-helium | | |

*/ N - a glass micro sphere number, n - a number of a cycle when the crystallite arises.

A necessary condition to form stable transparent cryogenic layer inside a micro sphere is a rather high rarefaction in the layering module and in the test chamber. Filling the chamber with heat-exchanged helium up to a pressure higher than 10 mTorr results in the complete crystallization of the transparent layer. The crystals obtained melt within a narrow range of 14-14.1K, i.e., near the triple point of the pure H₂ (FIG. 3, Table 1).

Another important condition is the removing of the water traces from micro spheres. The absorption spectra before and after drying a micro sphere were investigated with the help of SPECORD-M-80 IR spectrometer. The former spectrum has a wide absorption band at 3400 cm⁻¹, which is connected with the OH-valence oscillations of fixed water. After drying the micro spheres this absorption band disappears.

Therefore, the invention ensures the possibility of forming the cryogenic layer transparent in the whole domain of the existence of the solid-phase of hydrogen isotopes.

One of the possible mechanisms of the layer formation and the evolution is presented herein below. It should not be considered as a constraint of the invention in any of its part, but should favor a better understanding of the process.

The process of drop-wise condensation of hydrogen with the small HD additives takes place in the micro sphere inner space at its rapid cooling (FIG. 5) and is succeeded by quenching of its new formed finely dispersed modification on the extremely cold micro sphere wall. As a result the uniform meta-stable finely dispersed solid layer is formed. Its main characteristic during our experiments is its transparency. The presence of little HD in H₂ slows down the crystal growth into the solid cryolayer at its reheating. This method of cryolayer formation is identical to the manufacturing process to produce steel and alloys highly resistant to heat. It is based on liquid phase dispersing followed by its quenching in the presence of doping [11,12,17,26]. The obtained transparent layer shows evidence of aging under heating treatment as the substances listed above. A sign of ageing is transient state formation when spaces of stable crystal phase appear in the finely dispersed meta-stable (transparent) phase.

The experiments with the use of heat-exchanged gaseous helium have shown that the cryolayer mainly comprises hydrogen that melts near the triple point. These experiments have proved that micro sphere rapid cooling through the area of contact with the chamber wall is a necessary condition of the stable transparent cryolayer formation.

Other factors may occur in the above described system of micro sphere +H2/HD mixture as the consequence of the micro sphere preparing technique and the procedure of its filling with gas. In particular, they can bring little impurities of carbon monoxide, nitrogen oxide, etc. These factors can also influence the cryolayer properties and the way of its formation.

Those skilled in the art will easily understand that the invention can be realized in practice not only in accordance with the examples described herein above, which, in this connection, should not be considered as the constraint of the invention. Any possible modifications made in the frame of the concept described herein above are also covered by this invention, which is characterized by the claims given herein below.

### REFERENCES

1. Koresheva E. R. Hydrogen isotopes transport processes taking place in cryogenic targets, Ph.D.Thesis, Moscow-1984, 13 pages (in Russian)

2. Energy from Inertial Fusion. 1995 (IAEA, Vienna).

3. I. N. Krupskiy, Yu. E. Stetsenko, G. N. Chtcherbakov. Pis'ma v Zh.Exp.Teor.Fiz. vol.23(8) p.442, 1976.

4. V. S. Kogan, A. S. Bulatov, L. F. Yakimenko. Zh. Exp.Teor. Fiz. vol.46(1) p.148, 1964.

5. H. Roder, D. Childs, P. McKarthy. Sun'ey of the properties of the hydrogen isotopes below their critical temperatures. NBS Technical Note No.641, 1973.

6. V. B. Ginodman, G. A. Zaisev, A. I. Isakov el al. Lebedev Phys.Inst.Rept. No 8 p.8 1977.

7. G. W. Collins. Structure of vapor deposited solid hydrogen crystals. Presented at the 10th Target Fabrication Specialists' Mtg. (Feb. 6-10, 1995, Taos, N. Mex., USA).

8. J. K. Hoffer, L. R. Foreman. Phys.Rev.Lett vol.60 p.1310, 1988.

9. C. M. Chen, T. Norimatsu, Y. Tsuda, T. Yamanaka. S. Nakai. J.Vac.Sci.Tech.A vol.11 p.509, 1993.

10. G. W. Collins, D. N. Bittner, E. Monsler et al. J.Vac.Sci.Technol. A. vol.14(5) p.2897, 1996.

11. T. Ichikawa. Phys. Stat. Soi. (a)vGS.19No.2 p. 707, 1973.

12. S. Sachdev, D. R. Nelson. Phys. Rev. B vol.32 No.7 p.4592, 1985.

13. E. R. Koresheva. P. N. Lebedev Inst. Rept. No.12 p.35, 1984.

14. E. R. Koresheva, Yu. A. Merkuliev, A. I. Nikitenko et al. Laser and Particle Beams vol.6 pt.2 p.245, 1988.

15. E. R. Koresheva, A. I. Nikitenko, I. E. Osipov et al. The laser cryotarget formation and its delivery methods developed at Lebedev Institute. Proc. 21st European conference on Laser Interaction with Matter p.227 (21st ECLIM, Oct. 21-25, 1991, Warsaw, Poland)

16. I. V. Aleksandrova, E. R. Koresheva, I. E. Osipov. J. Moscow Phys.Soc. vol.3 p.85 1993.

17. I. I.Novikov, M. V. Zacharov. Termicheskaya obrabotka metallov i splavov. Moskwa 1962 (in Russian)

18. Proceedings of the Lebedev Physical Inst. vol.220, 1992.

19. I. E. Osipov, E. R. Koresheva, G. D. Baranov. J. Moscow Phys. Soc. vol. 9 p.301, 1999

20. E. R Koresheva, I. V. Aleksandrova, G. D. Baranov et al. p 897. In: Inertial Fusion Science and Application 99. (ELSEV I ER, 1999).

21. I. V. Aleksandrova, E. R. Koresheva, I. E. Osipov et al. Fusion Technology vol.38 No.1 p.166.2000.

22. N. G. Bereznyak, I. V. Bogoyavlenskii, L. V. Kamatsevich, A. A. Sheinina. Ukr. Fiz. Zh. vol.19 No3 p.472, 1974.

23. N. G. Bereznyak- I. V. Bogoyavlenskii, L. V. Kamatsevich- V. S. Kogan. Zh. Exp.Teor. Fiz. vol.57 p.1937, 1969.

24. P. C. Souers. Hydrogen properties for fusion energy. Lawrence Livermore National laboratory. University of California Press, 1986.

25. V. T. Nenarokomova, N. N. Riazantseva, Yu. A. Mileshkui. Atomnaya Eneigiya vol. 1 No.2 p.120, 1994 (in Russian).

26. Physical Metallurgy. Ed. R. W. Cahn. University of Sussex, England. 1965. Chapters VI-XII.

Therefore we claim:

1. A fuel core, representing a micro sphere, the inner surface of which features a condensed fuel layer also containing doping elements, the above layer being stably transparent and smooth throughout the entire range of the existence of its solid phase.

2. The fuel core according to claim 1 wherein the outside layer (micro sphere) is made from the material effectively compressing the fuel, e.g., such as polystyrene, glass, beryllium or beryllium deuteride, etc.

3. The fuel core according to claim 1 having the diameter of 500 μm minimum.

4. The fuel core according to claim 1 wherein the cryogenic layer of the fusion fuel comprises the hydrogen isotopes, e.g., such as D2 or DT.

5. The fuel core according to claim 1 wherein the cryogenic layer of the fusion fuel has thickness of 10 μm minimum.

6. The fuel core according to claim 1 wherein the cryogenic layer of the fusion fuel contains the doping elements slowing down crystal grain growth, e.g., such as HD, DT, CO, CO₂, NH₃, CH₄ and the like; such elements constituting 3% maximum of the total mass of the cryogenic layer.

7. The fuel core according to claim 1 wherein the cryogenic layer of the fusion fuel retains its transparency and smoothness over a period of one hour and longer in the temperature range from 5K to melting temperature.

8. The fuel core according to claim 1 wherein the extent of roughness of the free surface of the cryogenic layer of the fusion fuel is 0.5 μm maximum.

9. A method of producing of the fuel core according to claim 1, which includes dispersion of the liquid phase of the fusion fuel and quenching of the same on a micro sphere cooled wall in the presence of doping elements.

10. The method of producing of the fuel core according to claim 9 wherein dispersion is achieved through dropwise condensation of the fusion fuel vapor inside the micro sphere volume in the presence of alloying elements.

11. The method of producing of the fuel core according to claim 9 wherein quenching is achieved though settling of the liquid fuel micro drops containing doping elements onto the micro sphere surface cooled below the fuel melting temperature.

12. The method according to claim 9 wherein the doping elements are HD, DT, CO, CO₂, NH₃, CH₄ and the like constituting 3% maximum of the total mass of the cryogenic layer.

13. The method according to claim 9 wherein the fuel core features a cryogenic layer of the fusion fuel also containing doping elements, the above layer being stably transparent and smooth throughout the entire range of the existence of its solid phase.

14. The method according to claim 9 wherein the outside layer of the micro sphere is made from the material effectively compressing the fuel, e.g., such as polystyrene, glass, beryllium or beryllium deuteride, etc.

15. The method according to claim 9-14 wherein the fuel core has the diameter of 500 μm minimum.

16. The method according to claim 9 wherein the cryogenic layer of fusion fuel consists of hydrogen isotopes, e.g., such as D2 or DT.

17. The method according to claim 9 wherein the cryogenic layer of the fuel core has thickness of 10 μm minimum.

18. The method according to claim 9 wherein the cryogenic layer of the fuel core contains doping elements slowing down crystal grain growth, e.g., such as HD, DT, CO, CO₂, NH₃, CH₄ and the like; such elements constituting 3% maximum of the total mass of the cryogenic layer.

19. The method according to claim 9 wherein the cryogenic layer of the fuel core retains its transparency and smoothness over a period of one hour or longer in the temperature range from 5K to the melting temperature.

20. The method according to claim 9 wherein the extent of roughness of the free surface of the cryogenic layer of the fusion core is 0.5 μm maximum.

21. The method according to claim 10 wherein the doping elements are HD, DT, CO, CO₂, NH₃, CH₄ and the like constituting 3% maximum of the total mass of the cryogenic layer.

22. The method according to claim 10 wherein the fuel core features a cryogenic layer of the fusion fuel also containing doping elements, the above layer being stably transparent and smooth throughout the entire range of the existence of its solid phase.

23. The method according to claim 10 wherein the outside layer of the micro sphere is made from the material effectively compressing the fuel, e.g., such as polystyrene, glass, beryllium or beryllium deuteride, etc.

24. The method according to claim 10 wherein the fuel core has the diameter of 500 μm minimum.

25. The method according to claim 10 wherein the cryogenic layer of fusion fuel consists of hydrogen isotopes, e.g., such as D2 or DT.

26. The method according to claim 10 wherein the cryogenic layer of the fuel core has thickness of 10 μm minimum.

27. The method according to claim 10 wherein the cryogenic layer of the fuel core contains doping elements slowing down crystal grain growth, e.g., such as HD, DT, CO, CO₂, NH₃, CH₄ and the like; such elements constituting 3% maximum of the total mass of the cryogenic layer.

28. The method according to claim 10 wherein the cryogenic layer of the fuel core retains its transparency and smoothness over a period of one hour or longer in the temperature range from 5K to the melting temperature.

29. The method according to claim 10 wherein the extent of roughness of the free surface of the cryogenic layer of the fusion core is 0.5 μm maximum.

30. The method according to claim 11 wherein the doping elements are HD, DT, CO, CO₂, NH₃, CH₄ and the like constituting 3% maximum of the total mass of the cryogenic layer.

31. The method according to claim 11 wherein the fuel core features a cryogenic layer of the fusion fuel also containing doping elements, the above layer being stably transparent and smooth throughout the entire range of the existence of its solid phase.

32. The method according to claim 11 wherein the outside layer of the micro sphere is made from the material effectively compressing the fuel, e.g., such as polystyrene, glass, beryllium or beryllium deuteride, etc.

33. The method according to claim 11 wherein the fuel core has the diameter of 500 μm minimum.

34. The method according to claim 11 wherein the cryogenic layer of fusion fuel consists of hydrogen isotopes, e.g., such as D2 or DT.

35. The method according to claim 11 wherein the cryogenic layer of the fuel core has thickness of 10 μm minimum.

36. The method according to claim 11 wherein the cryogenic layer of the fuel core contains doping elements slowing down crystal grain growth, e.g., such as HD, DT, CO, CO₂, NH₃, CH₄ and the like; such elements constituting 3% maximum of the total mass of the cryogenic layer.

37. The method according to claim 11 wherein the cryogenic layer of the fuel core retains its transparency and smoothness over a period of one hour or longer in the temperature range from 5K to the melting temperature.

38. The method according to claim 11 wherein the extent of roughness of the free surface of the cryogenic layer of the fusion core is 0.5 μm maximum.

39. The method according to claim 12 wherein the fuel core features a cryogenic layer of the fusion fuel also containing doping elements, the above layer being stably transparent and smooth throughout the entire range of the existence of its solid phase.

40. The method according to claims 12 wherein the outside layer of the micro sphere is made from the material effectively compressing the fuel, e.g., such as polystyrene, glass, beryllium or beryllium deuteride, etc.

41. The method according to claim 12 wherein the fuel core has the diameter of 500 μm minimum.

42. The method according to claim 12 wherein the cryogenic layer of fusion fuel consists of hydrogen isotopes, e.g., such as D2 or DT.

43. The method according to claim 12 wherein the cryogenic layer of the fuel core has thickness of 10 μm minimum.

44. The method according to claim 12 wherein the cryogenic layer of the fuel core contains doping elements slowing down crystal grain growth, e.g., such as HD, DT, CO, CO₂, NH₃, CH₄ and the like; such elements constituting 3% maximum of the total mass of the cryogenic layer.

45. The method according to claim 12 wherein the cryogenic layer of the fuel core retains its transparency and smoothness over a period of one hour or longer in the temperature range from 5K to the melting temperature.

46. The method according to claim 12 wherein the extent of roughness of the free surface of the cryogenic layer of the fusion core is 0.5 μm maximum.

47. The method according to claim 13 wherein the outside layer of the micro sphere is made from the material effectively compressing the fuel, e.g., such as polystyrene, glass, beryllium or beryllium deuteride, etc.

48. The method according to claim 13 wherein the fuel core has the diameter of 500 μm minimum.

49. The method according to claim 13 wherein the cryogenic layer of fusion fuel consists of hydrogen isotopes, e.g., such as D2 or DT.

50. The method according to claim 13 wherein the cryogenic layer of the fuel core has thickness of 10 μm minimum.

51. The method according to claim 13 wherein the cryogenic layer of the fuel core contains doping elements slowing down crystal grain growth, e.g., such as HD, DT, CO, CO₂, NH₃, CH₄ and the like; such elements constituting 3% maximum of the total mass of the cryogenic layer.

52. The method according to claim 13 wherein the cryogenic layer of the fuel core retains its transparency and smoothness over a period of one hour or longer in the temperature range from 5K to the melting temperature.

53. The method according to claim 13 wherein the extent of roughness of the free surface of the cryogenic layer of the fusion core is 0.5 μm maximum.

54. The method according to claim 14 wherein the fuel core has the diameter of 500 μm minimum.

55. The method according to claim 14 wherein the cryogenic layer of fusion fuel consists of hydrogen isotopes, e.g., such as D2 or DT.

56. The method according to claim 14 wherein the cryogenic layer of the fuel core has thickness of 10 μm minimum.

57. The method according to claim 14 wherein the cryogenic layer of the fuel core contains doping elements slowing down crystal grain growth, e.g., such as HD, DT, CO, CO₂, NH₃, CH₄ and the like; such elements constituting 3% maximum of the total mass of the cryogenic layer.

58. The method according to claim 14 wherein the cryogenic layer of the fuel core retains its transparency and smoothness over a period of one hour or longer in the temperature range from 5K to the melting temperature.

59. The method according to claim 14 wherein the extent of roughness of the free surface of the cryogenic layer of the fusion core is 0.5 μm maximum.

60. The method according to claim 15 wherein the cryogenic layer of fusion fuel consists of hydrogen isotopes, e.g., such as D2 or DT.

61. The method according to claim 15 wherein the cryogenic layer of the fuel core has thickness of 10 μm minimum.

62. The method according to claim 15 wherein the cryogenic layer of the fuel core contains doping elements slowing down crystal grain growth, e.g., such as HD, DT, CO, CO₂, NH₃, CH₄ and the like; such elements constituting 3% maximum of the total mass of the cryogenic layer.

63. The method according to claim 15 wherein the cryogenic layer of the fuel core retains its transparency and smoothness over a period of one hour or longer in the temperature range from 5K to the melting temperature.

64. The method according to claim 15 wherein the extent of roughness of the free surface of the cryogenic layer of the fusion core is 0.5 μm maximum.

65. The method according to claim 16 wherein the cryogenic layer of the fuel core has thickness of 10 μm minimum.

66. The method according to claim 16 wherein the cryogenic layer of the fuel core contains doping elements slowing down crystal grain growth, e.g., such as HD, DT, CO, CO₂, NH₃, CH₄ and the like; such elements constituting 3% maximum of the total mass of the cryogenic layer.

67. The method according to claim 16 wherein the cryogenic layer of the fuel core retains its transparency and smoothness over a period of one hour or longer in the temperature range from 5K to the melting temperature.

68. The method according to claim 16 wherein the extent of roughness of the free surface of the cryogenic layer of the fusion core is 0.5 μm maximum.

69. The method according to claim 17 wherein the cryogenic layer of the fuel core contains doping elements slowing down crystal grain growth, e.g., such as HD, DT, CO, CO₂, NH₃, CH₄ and the like; such elements constituting 3% maximum of the total mass of the cryogenic layer.

70. The method according to claim 17 wherein the cryogenic layer of the fuel core retains its transparency and smoothness over a period of one hour or longer in the temperature range from 5K to the melting temperature.

71. The method according to claim 17 wherein the extent of roughness of the free surface of the cryogenic layer of the fusion core is 0.5 μm maximum.

72. The method according to claim 18 wherein the cryogenic layer of the fuel core retains its transparency and smoothness over a period of one hour or longer in the temperature range from 5K to the melting temperature.

73. The method according to claim 18 wherein the extent of roughness of the free surface of the cryogenic layer of the fusion core is 0.5 μm maximum.

74. The method according to claim 19 wherein the extent of roughness of the free surface of the cryogenic layer of the fusion core is 0.5 μm maximum.

75. Cryogenic layer of the fuel core, which is stably transparent and smooth throughout the entire range of existence of its solid phase.
